(19) United States
(12) Patent Application Publication
(10) Pub. No.: US 2017/0130855 A1
(43) Pub. Date: May 11, 2017

(54) Pressure Assisted Two-Position Three-Way Poppet Valve

(71) Applicants: Frank Groves, Ben, OR (US); Josh Groves, Traverse City, MI (US); Tyler Zawacki, Traverse City, MI (US)

(72) Inventors: Frank Groves, Ben, OR (US); Josh Groves, Traverse City, MI (US); Tyler Zawacki, Traverse City, MI (US)

(21) Appl. No.: 14/857,853

(22) Filed: Sep. 18, 2015

(51) Int. Cl. F16K 27/02; F16K 31/122; F16K 47/02; F16K 11/04

(52) U.S. Cl. CPC F16K 27/0263; F16K 11/04; F16K 31/1221; F16K 47/023

(57) ABSTRACT

Systems, methods, and apparatus for a valve assembly are provided. The valve assembly may include a housing and a poppet. The poppet may be located within the housing.

### BACKGROUND

This invention relates to the need for providing reliable hydraulic control in demanding and critical environments typical of, but not exclusive to, offshore and subsea applications. Many of these applications exist on BOPs and ROVs, such as actuation of important BOP functions in case of an emergency. It is commonly desired that such valves operate with high functional reliability, zero or minimal possible leakage, and possess a long service life.

Two-position pilot-operated hydraulic control valves are widely used throughout many industries, including the offshore and subsea industries. Often valves specifically related to BOP applications and functions are referred to as Sub-Plate Mounted (SPM) valves, but they can generally be considered hydraulic control valves regardless of mounting style. When the valve is in the closed position, communication is blocked between the supply port and the outlet port and the outlet port is connected to the vent port. When the valve is in the open position, the supply port is in communication with the outlet port, and the vent port is blocked.

Typical valves in this application are most commonly of the form found in U.S. Pat. No. 5,778,918 A, McLelland, 1998 and US 20140061516 A1, Gustafson, Goode, and Bailey, 2014. Nearly all of these valves have a central sheath which seals off one port while connecting the other two. Normally, the inlet port is on the side, the function port is at or near the bottom, and the vent port is on the side. Sealing methods vary based on valve configuration, but there are usually face seals against a central cage or sheath. Valves of this style frequently suffer from several issues, including sticking in mid-position, flow force susceptibility, low flow efficiency for size, wear, misalignment, lack of damping, lack of impact control, and water-hammer. Some of these issues have been reduced, but the nature of the design inherently limiting in dealing with most of them.

### DESCRIPTION OF THE FIGURES

FIG. 1 is an isometric view of the valve design.

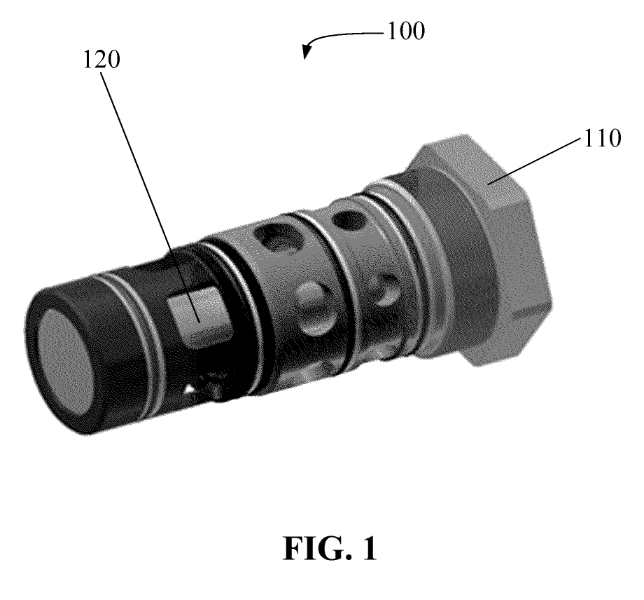

### DETAILED DESCRIPTION

This valve 100 is applicable to a wide array of applications where two-position three-way hydraulic valves are utilized. It will be especially valuable in cases where current generation SPM valve short-comings (flow force susceptibility, wear, short service life, water-hammer) are causing issues. Typically, these applications will be ones that require greater flow efficiency, extreme reliability, and near zero leakage as this valve design greatly improves upon these areas and many of the others.

The valve design utilizes a piloted poppet 120 which is designed to rapidly shift between two end-stroke positions. The poppet 120 in the closed position creates a metal on metal seal to the housing 110 preventing fluid communication between the working port and the supply port while allowing communication between the working port and the vent port. In the open position, the vent port is isolated, while the supply and working ports are in communication.

A key feature of this design is the pressure assisted seating which creates a large sealing force and allows the valve 100 to be near zero-leak in both positions. In the closed position, this is achieved by having the supply port pressure fed into the spring chamber of the poppet 120. The pilot port is vented and the spring and supply pressure combine to create a large force on the poppet 120 creating a strong seal between the poppet 120 and the housing 110. In the open position, the pilot port is provided with supply port pressure. The pilot area is noticeably larger than the spring chamber area and so it creates a large force in the opposite direction and thus a strong seal in the opposite end-stroke position.

Another advantage of this design is that the large forces created in each direction result in fast shifting times. The faster shifting times minimize time the valve 100 spends in a cross-over position with all ports connected. The design of this valve 100 also allows for significant control over port and poppet 120 geometry to reduce flow forces and the large shifting/sealing force insure that the valve 100 does not get stuck in a mid-position.

Further advantages of the valve 100 include very high reliability and long service life. This is due to the wear resistance of the sealing technology, inability of the poppet 120 to become internally misaligned, and the hydraulic cushions which insure the impact speeds when metal contacts metal are well below levels which could cause damage. The cushions then also help to reduce water-hammer in the wider hydraulic system.

Final advantages include a velocity control orifice and the physical orientation of the ports. The orientation of the ports combined with the design of the valve 100 allows for a more efficient flow path as compare to a current generation design SPM valve of the same physical size.

What is claimed is:

1-8. (canceled)

9. A valve assembly comprising:
a housing; and
a poppet located within the housing.
